(19) United States
(12) Patent Application Publication
(10) Pub. No.: US 2017/0251806 A1
(43) Pub. Date: Sep. 7, 2017

(54) HEIGHT-ADJUSTABLE TABLE OR DESK

(71) Applicant: Scott NEWMAN, Dallas, TX (US)

(72) Inventor: Scott NEWMAN, Dallas, TX (US)

(21) Appl. No.: 15/450,695

(22) Filed: Mar. 6, 2017

Related U.S. Application Data
(60) Provisional application No. 62/304,848, filed on Mar. 7, 2016.

(51) Int. Cl. A47B 21/02; A47B 9/20; H01R 27/02; A47B 83/04; H01R 25/00; A47B 13/08; A47B 21/06

(52) U.S. Cl. CPC A47B 21/02; A47B 13/086; A47B 9/20; A47B 21/06; A47B 83/045; H01R 25/006; H01R 27/02; A47B 2021/066

(57) ABSTRACT

A table or desk includes: a surface; a substrate, wherein the surface is attached to an upper plane of the substrate; and at least one leg directly or operatively connected to an underneath side of the substrate, wherein the leg is height adjustable. The height of the table or desk can be adjusted by raising and lowering the surface and the substrate via a motor. The motor can be controlled by a variety of mechanisms and can adjust the height by moving telescoping leg segments into and out of position with each other. The table or desk can be used in a home or office setting.

### TECHNICAL FIELD

Tables and desks are widely used in home and office settings. Standing desks or workstations can provide ergonomic benefits to people who work long hours at a desk. Moreover, tables can be used in a home setting for dining, entertaining, working on art projects, etc. A height-adjustable table or desk can be used in a home and/or office setting.

### BRIEF DESCRIPTION OF THE FIGURES

The features and advantages of certain embodiments will be more readily appreciated when considered in conjunction with the accompanying figures. The figures are not to be construed as limiting any of the preferred embodiments.

FIG. 1 is a back perspective view of a desk according to certain embodiments.

FIG. 2 is a partial side and top view of the desk.

FIG. 3 is a perspective view of a cable management system from FIG. 1.

FIG. 4 is a bottom view of the desk showing attachment of legs to a substrate according to certain embodiments.

FIG. 5 is a bottom view of the desk showing connections to various power supplies according to certain embodiments.

FIG. 6 is a cross-sectional view of the desk surface and substrate according to certain embodiments.

FIGS. 7A -7D are top views of different shapes of the desk's surface according to various embodiments.

### DETAILED DESCRIPTION

Tables and desks have been used in home and office settings for providing various functions, including eating, working, entertaining, and performing a multitude of projects. Some of the drawbacks to traditional tables and desks include, but are not limited to: generally there is no way to adjust the height of the table or desk surface, which requires a chair that is height adjustable; it is difficult for persons of various heights to use the same table or desk; the surface of the table or desk is generally made of a material that does not allow for writing on the surface without permanent disfigurement of the surface- in which case, some form of notepad or paper has to be kept close by for taking notes. Thus, there is a need for an improved table or desk.

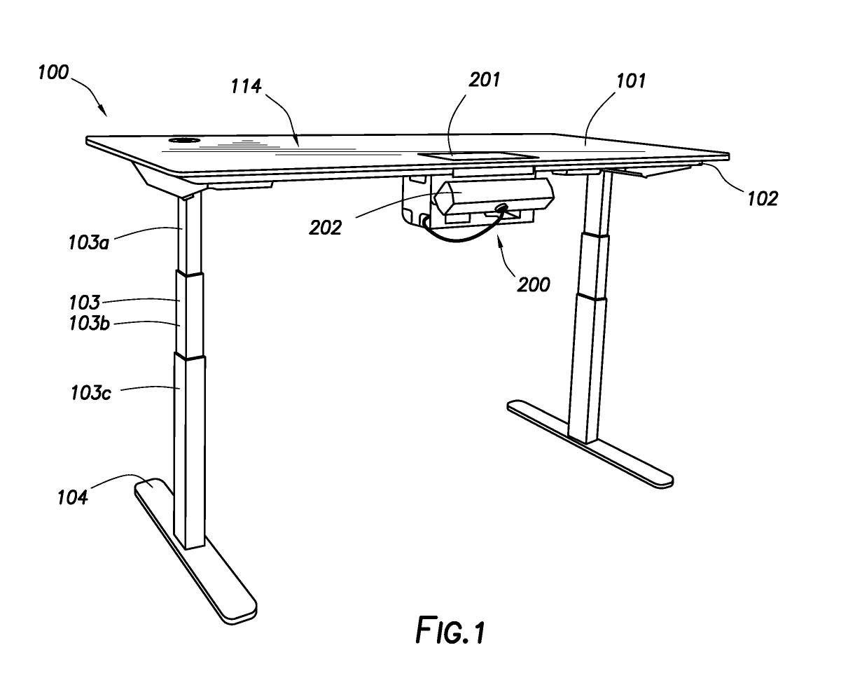

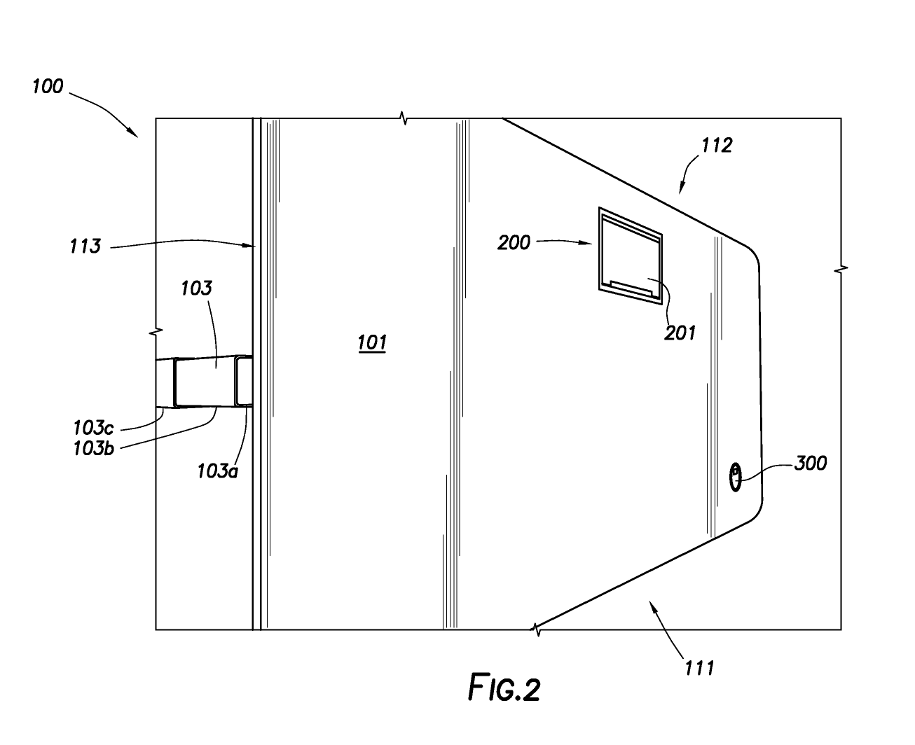

A height-adjustable table or desk is provided. Turning to the Figures, FIGS. 1 and 2 depict a desk 100 according to certain embodiments. It is to be understood that even though the drawings depict a desk, the various embodiments are equally applicable to a table. As used herein, reference to a “desk” also means a “desk or table” without the need to continually refer to the alternative throughout. A desk can be used as a work station in a home or office setting. A table can be used as a dining room table, a conference table in an office setting, or an arts and crafts station for adults or children. The desk can also be used as a drafting table and include a surface that tilts away from the legs. The tilt of a back of the surface can be in the range of about 5° to about 50° from a horizontal plane. Tilting desks can be useful for architects or draftsmen.

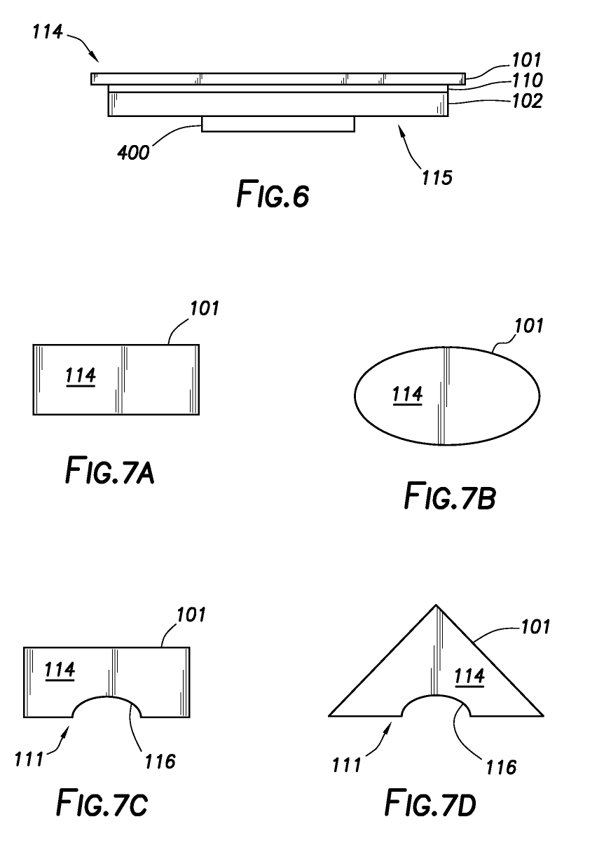

The desk 100 can include a substrate 102, a surface 101, and two or more legs or columns 103. According to cetain embodiments, the desk 100 may only include one leg-depending, in part, on the dimensions of the surface. According to certain embodiments, the surface 101 is attached to an upper plane of the substrate 102. The surface 101 can be attached to the substrate 102 in a variety of manners. By way of example, as depicted in FIG. 6, the surface 101 can be attached to an upper plane of the substrate 102 via an adhesive material 110. The adhesive material 110 can be used to permanently attach the surface 101 to the substrate 102. According to certain other embodiments, the surface 101 can be attached to the substrate 102 by one or more fasteners (e.g., nails or screws). The outer dimensions of the surface 101 can be greater than or equal to the outer dimensions of the substrate 102. When the outer dimensions of the surface 101 are greater than the outer dimensions of the substrate 102, the surface can overhang the substrate and form an edge.

The substrate 102 can be made from a variety of materials, including but not limited to, metals, wood, wood products, and plastics. The surface 101 can be made from a variety of materials, including but not limited to, a dry-erase glass, wet-erase glass, minerals (e.g., granite, quartz, marble, or any precious stone), stone, wood, wood veneer, wood products, and plastics. In a preferred embodiment, the surface 101 is made from a dry-erase glass or wet-erase glass. An upper surface of the glass can be a coated with an enamel coating or the glass can be tempered glass; thus, allowing for marks from a marker (including dry-erase markers) to be removed via an eraser or dampened cloth. Dry-erase and wet-erase glass can be made from a non-porous material or include a non-porous coating. The non-porous material or coating can prevent ink from a marker from penetrating into the glass, whereby the ink could be permanently embedded within the glass. Moreover, the glass can be best adapted for use with dry-erase or wet-erase markers. These markers generally include chemicals that allow for rapid drying of the carrier solvent for the ink. This rapid drying can inhibit or prevent the ink from penetrating into the glass surface. As such, according to certain embodiments, a person can mark on the surface 101 of the desk 100, for example, writing or drawings, and then remove the marks at a later time if desired. In this manner, a person can take notes or jot down other important items to either remain on the surface or be removed when desired. This can alleviate the need to keep paper or other material nearby when needing to take notes.

According to certain embodiments, when the surface 101 is transparent, the upper plane of the substrate 102 can be painted or stained and/or the surface 101 can be colored or painted. This embodiment can be useful to provide colors for the desk 100. The colors can be a variety of colors and can be customized and selected by the purchaser of the desk 100. In this manner, the desk 100 can fit with any decor in an office or home setting. The desk 100 can also include a modesty panel (not shown) that is attached to the front 111 of the desk. The modesty panel can be a thin board of wood or metal that is attached to the front of a desk. It is intended to shield legs, ankles, or feet from view in a variety of circumstances. The modesty panel provides privacy for the person seated at the desk because it covers the upper part of the legs.

The desk 100 can also include two or more height-adjustable legs 103. The legs 103 can be used to adjust the height of the substrate 102 and the surface 101. The legs 103 can be adjusted to provide a substrate 102 and surface 101 heights in a range from about 18 inches to about 55 inches. The legs 103 can include two or more segments or portions that can telescopically connect to each other. By way of example, as shown in FIGS. 1 and 2, the legs 103 can include a first telescoping segment 103a, a second telescoping segment 103b, and a third telescoping segment 103c. Of course, the legs 103 can include only two telescoping segments or can include more than three telescoping segments.

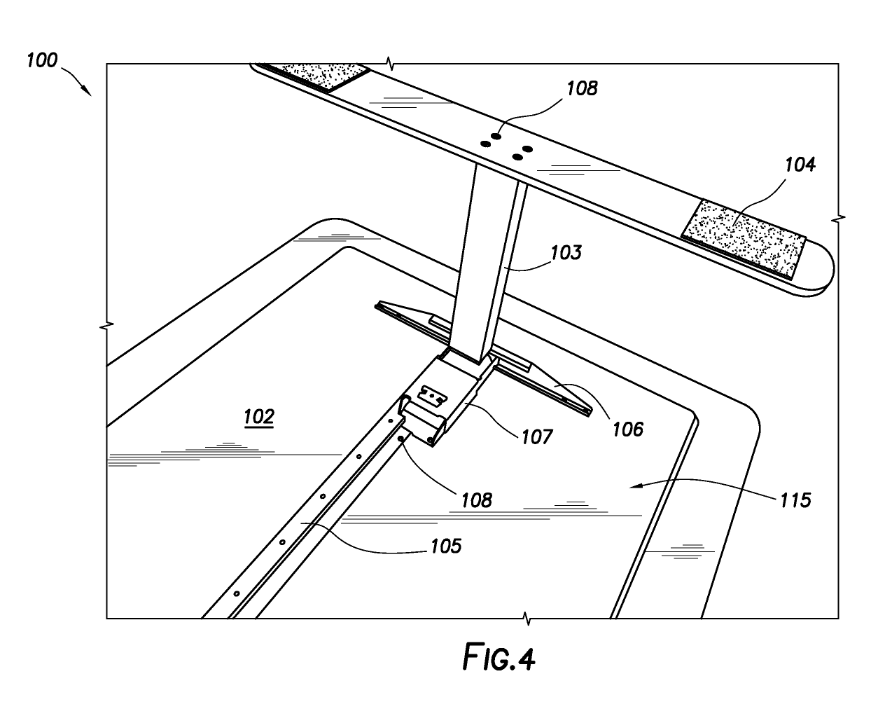

As can be seen in FIG. 4, the legs 103 can be affixed to a lower plane of the substrate 102. The lower plane of the substrate 102 is the bottom 115 of the desk. According to certain embodiments, the legs 103 can be affixed to the bottom 115 of the desk via attachment to a horizontal support 105 located on the bottom 115 of the desk. The horizontal support 105 can be permanently attached (for example, by an adhesive) or removably attached to the bottom 115 of the desk (for example, via fasteners 108). The horizontal support 105 can include holes for receiving the fasteners 108. The fasteners 108 can be for example, nails or screws. According to certain embodiments, the legs 103 are connected to the horizontal support 105 by a click/lock mechanism 107. The click/lock mechanism 107 can include one or more flanges that insert into and mate with one or more voids or recesses, whereby the flanges can retract when pushed into the void or recess and then expand within the void or recess to lock the legs 103 to the bottom 115 of the desk. According to certain other embodiments, the legs 103 are permanently or removably attached to the horizontal support 105 via spot welding, for example, or fasteners. The desk 100 can further include a perpendicular support 106 to affix the legs 103 to the bottom 115 of the desk. The perpendicular support 106 can be permanently or removably attached to the bottom 115 of the desk and can be connected to the click/lock mechanism 107 or the legs 103.

Feet 104 can be attached to or can be an integral component of the bottom of the legs 103. The feet 104 can be used to stabilize the desk 100 on a floor from movement or tipping over. The feet 104 can be attached to the legs 103 via fasteners 108. According to other embodiments, the feet 104 are an integral component of the legs 103. The legs 103 and feet 104 can be made out of a variety of materials. Suitable materials include, but are not limited to, metals, metal alloys, composite materials, carbon fiber, plastics (including thermoset plastics), and other materials. Examples of suitable metals or metal alloys include, but are not limited to, aluminum and steel. According to certain embodiments, the legs 103 have a sufficient strength to withstand an axial loading applied from the substrate 102, the surface 101, force from people, and objects placed on the surface 101. The “strength” of a material is its ability to withstand an applied load without failure or plastic deformation. Preferably, the material for the legs 103 is selected such that the legs have the sufficient strength to withstand an axial loading.

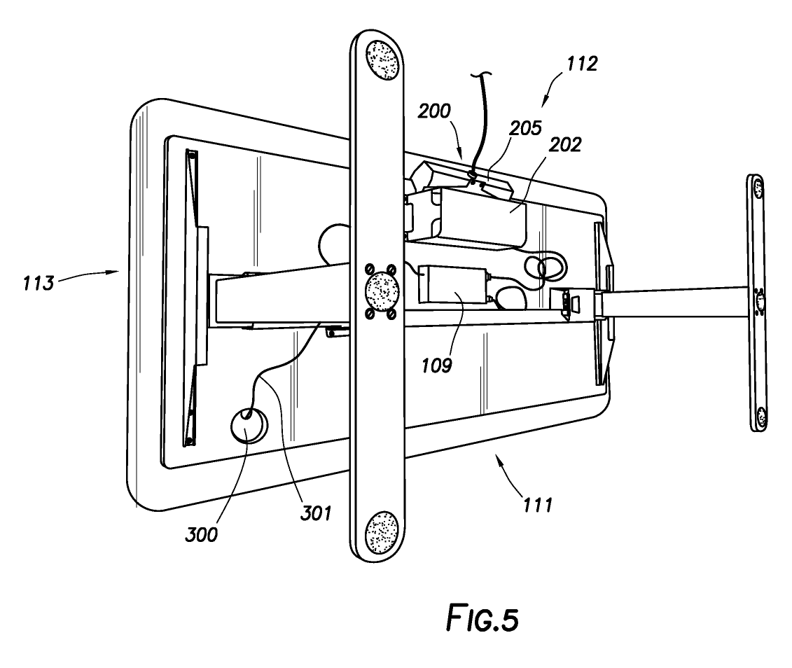

The legs 103 can be adjusted via a variety of mechanisms. As can be seen in FIGS. 2 and 5, the desk 100 can include a control panel 300 and a connecting cable 301 for connecting the control panel 300 to a power supply 109. The control panel 300 can be located near a front 111 of the desk and side 113 of the desk. The connecting cable 301 and power supply 109 can be located underneath the substrate 102 at the bottom 115 of the desk. The control panel 300 can be used to send instructions to a motor (not shown) to raise or lower the substrate 102 and surface 101 via a telescopic mechanism or an electronic mechanism. For example, the telescoping segments 103a/103b/103c can be moved into and out of each other via electronics and the motor in order to raise or lower the height of the substrate 102 and surface 101. The motor can be located within the legs 103 or adjacent to the legs 103, for example, as part of the click/lock mechanism 107. The motor can be an energy-efficient motor, using low wattage (i.e., less than 1 watt of energy), and the motor can also have a low noise level. A sensor (not shown) can also be included to determine if the telescoping segments become stuck (i.e., are impaired or prevented from moving) whereby damage to the motor or legs could occur. The sensor, when sensing the segments are stuck, can send a signal to the motor to stop the motor, thereby preventing possible damage. The control panel 300 can include programmable features and/or memory settings for a particular user's preferred height or different heights for sitting versus standing. Although not shown, a lever or toggle switch that can be positioned on a top 114 of the desk surface 101 or underneath the substrate 102 at the bottom 115 of the desk to instruct the motor to raise or lower the height of the surface 101. According to certain other embodiments, a mobile phone application can be used to remotely direct the motor by pairing the mobile phone to the motor via Bluetooth. The mobile phone application can be for Android or IOS phones. Additionally, a computer software program can also be used to remotely direct the motor. According to certain other embodiments, the motor can be directed by a battery-powered remote control.

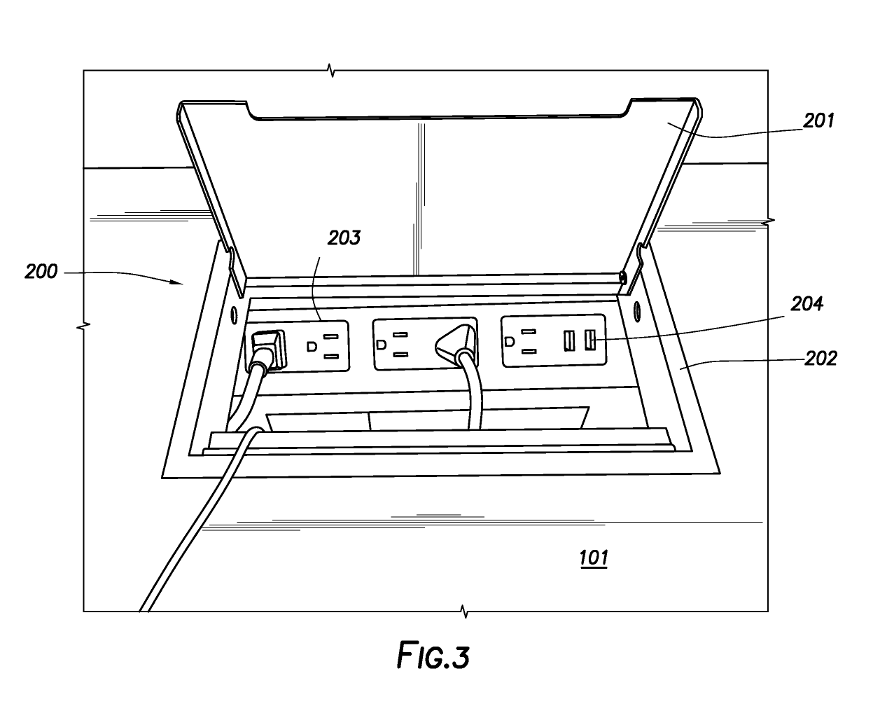

As shown in FIGS. 1-5, the desk 100 can also include a cable management system 200. The cable management system 200 can be located at or near the back 112 of the desk and towards the middle or a side 113 of the desk. The cable management system 200 can include a housing 202 and a lid or grommet lid 201. The housing 202 can be located on the bottom 115 of the desk. The lid 201 can be located on the top 114 of the desk. The housing 202 and the lid 201 can be made from a variety of materials including, but not limited to, metals, metal alloys, and plastics. As can be seen in FIG. 3, the lid 201 can be used to access the inside of the housing 202 by lifting or raising the lid.

The cable management system 200 can be used to supply a source of power to computer equipment, including but not limited to monitors, speakers, computer towers, and laptops. The cable management system 200 can also be used to provide ports for connecting one or more electronic devices, for example, via a Universal Serial Bus “USB” or Ethernet cable, or computer equipment, for example, via a video graphic array “VGA” connector, high-definition multimedia interface “HDMI” connector, or digital visual interface “DVI” connector. One or more electrical outlets 203 and one or more ports 204 can be accessed within the housing whereby a power cord can be plugged into the electrical outlets 203 and/or electronic devices can be plugged into a port 204. The power supply 109 for the legs 103 can plug into an electrical outlet 203 of the cable management system 200.

As shown in FIG. 5, the cable management system 200 can also include a power supply 205 that can be located underneath the substrate 102 on the bottom 115 of the desk. The power supply 205 can also be located inside the cable management housing 202. The power supply 205 can be used to supply power to the electrical outlets 203. It is to be understood that any number of electrical outlets and/or ports can be used and vary in the arrangement or configuration. The housing 202 can have a variety of dimensions and the dimensions can be selected based, in part, on the number of outlets and ports to be included in the cable management system 200.

The desk 100 can also include more than one cable management system 200 that are located in different positions on the desk 100. By way of example, a first cable management system 200, containing predominately or exclusively electrical outlets 203 can be located near the back 112 of the desk, while a second cable management system 200, containing predominately or exclusively ports 204 can be located near the front 111 and side 113 of the desk.

As shown in FIG. 6, the desk 100 can further include a drawer 400. The drawer 400 can be mounted underneath the substrate 102 at the bottom 115 of the desk. There can also be more than one drawer 400. The number of drawers 400 and the dimensions can vary. The drawer(s) 400 can include pulls or handles and slides for opening and closing the drawer(s). The drawer(s) can be opened towards the front 111 of the desk. Any of the drawers can have a width in the range from about 8 inches to about 55 inches, a height in the range from about 2 inches to about 8 inches, and a depth in the range from about 14 inches to about 24 inches. The drawer(s) 400 can be made from metals, metal alloys, wood, wood products, and plastics.

Turning to FIGS. 7A-7D, the substrate 102 and the surface 101 can have a variety of shapes, including square, rectangular, circular, oval, elliptical, triangular, and L-shaped. The substrate 102 and the surface 101 can be, but do not have to be, the same shape. The desk can further include a recess 116. The recess 116 can be located at the front 111 of the desk. The recess 116 can allow a person to be positioned closer to the back 112 of the desk. For example, the recess 116 can allow a chair or the person to move closer to the back of the desk, which can be useful to aid in seeing words on computer monitors.

The dimensions and thickness of the substrate 102 and surface 101 can vary. The dimensions and thickness of the substrate 102 and the surface 101 can be the same or different. The substrate 102 and the surface 101 can have width in a range of about 16 inches (in.) to about 60 in., a depth in a range from about 24 in. to about 120 in., and a thickness in a range from about 0.5 in. to about 3 in. The dimensions for a circular desk can include a radius in the range of about 12 in. to about 36 in. By way of example, a conference table can have dimensions of 48 in. by 96 in.; a kids' play table can have dimensions of 16 in. by 24 in.; and a dining room table can have dimensions of 36 in. by 72 in.

The desk 100 can be preassembled or assembled at the location of use. If assembly is required, then the assembly can include any of the following: securing the horizontal support 105 to the underneath of the substrate 102 (preferably in pre-drilled or marked holes); securing the perpendicular supports 106 to the underneath of the substrate 102 (preferably in pre-drilled or marked holes); attaching the legs 103 to the horizontal support 105 and optionally the perpendicular supports 106 via the click/lock mechanisms 107; securing the feet 104 to the legs 103 (preferably in pre-drilled or marked holes); securing the power supplies 109 and 205 to the underneath of the substrate 102; and connecting the connecting cable 301 from the control panel 300 to the power supply 109.

The advantages for utilizing standing desks is well known. In use, a person can use the height-adjustable desk in a predominately sitting height, a predominately standing height, or easily switch between sitting and standing heights. Moreover, due to the incremental steps of raising and lowering the surface 101, the desk 100 can comfortably accommodate any person's desired height such that the surface 101 is at the perfect height for that person.

Therefore, the present invention is well adapted to attain the ends and advantages mentioned as well as those that are inherent therein. The particular embodiments disclosed above are illustrative only, as the present invention may be modified and practiced in different, but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present invention.

As used herein, the words “comprise,” “have,” “include,” and all grammatical variations thereof are each intended to have an open, non-limiting meaning that does not exclude additional elements or steps. While devices, systems, and methods are described in terms of “comprising,” “containing,” or “including” various components or steps, the devices, systems, and methods also can “consist essentially of” or “consist of” the various components and steps. It should also be understood that, as used herein, “first,” “second,” and “third,” are assigned arbitrarily and are merely intended to differentiate between two or more segments, cable management systems, etc., as the case may be, and does not indicate any sequence. Furthermore, it is to be understood that the mere use of the word “first” does not require that there be any “second,” and the mere use of the word “second” does not require that there be any “third,” etc.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

What is claimed is:

1. A table or desk comprising:
a surface;
a substrate, wherein the surface is attached to an upper plane of the substrate; and
at least one leg directly or operatively connected to an underneath side of the substrate, wherein the leg is height adjustable.

2. The table or desk according to claim 1, wherein the substrate is made from a material selected from the group consisting of metals, metal alloys, wood, wood products, plastics, and combinations thereof.

3. The table or desk according to claim 1, wherein the surface is made from a material selected from the group consisting of dry-erase glass, wet-erase glass, minerals, stone, wood, wood veneer, wood products, and plastics.

4. The table or desk according to claim 1, wherein the surface is made from a dry-erase glass or wet-erase glass.

5. The table or desk according to claim 1, wherein the at least one leg adjusts the height of the substrate and the surface.

6. The table or desk according to claim 5, wherein the at least one leg comprises two or more segments telescopically connected to each other.

7. The table or desk according to claim 6, wherein the telescoping segments move into and out of each other via electronics and a motor in order to adjust the height of the substrate and the surface.

8. The table or desk according to claim 1, wherein the at least one leg is affixed to a lower plane of the substrate via attachment to a horizontal support located on the lower plane of the substrate.

9. The table or desk according to claim 8, wherein the at least one leg is connected to the horizontal support by a click/lock mechanism.

10. The table or desk according to claim 1, wherein the at least one leg has a sufficient strength to withstand an axial loading applied to a top of the leg.

11. The table or desk according to claim 1, further comprising a control panel and a connecting cable for connecting the control panel to a power supply, wherein the control panel sends instructions to a motor for raising and lowering the substrate and the surface.

12. The table or desk according to claim 1, wherein a motor raises and lowers the substrate and the surface via a lever, a toggle switch, a mobile phone application, a computer software program, or a battery-powered remote control.

13. The table or desk according to claim 1, further comprising a cable management system, wherein the cable management system comprises a housing and a lid.

14. The table or desk according to claim 13, wherein the lid is raised to access the inside of the housing.

15. The table or desk according to claim 14, wherein the housing contains one or more electrical outlets and one or more ports.

16. The table or desk according to claim 15, wherein the one or more ports are selected from the group consisting of a Universal Serial Bus connector, an Ethernet cable connector, a video graphic array connector, a high-definition multimedia interface connector, a digital visual interface connector, and combinations thereof.

17. The table or desk according to claim 1, wherein the substrate and the surface have a shape selected from square, rectangular, circular, oval, elliptical, triangular, and L-shaped.

18. The table or desk according to claim 1, wherein a front of the substrate and the surface further comprises a recess.

19. The table or desk according to claim 1, wherein the substrate and the surface have a width in the range of about 16 inches to about 60 inches, a depth in the range from about 24 inches to about 120 inches, and a thickness in the range from about 0.5 inches to about 3 inches.

20. The table or desk according to claim 1, further comprising a drawer located underneath a lower plane of the substrate.
